(19) United States
(12) Patent Application Publication
(10) Pub. No.: US 2007/0002782 A1
(43) Pub. Date: Jan. 4, 2007

(54) Enhanced DLS and HCCA principles

(75) Inventors: Jarkko Kneckt, Espoo (FI); Jari Jokela, Ylojarvi (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/208,197

(22) Filed: Aug. 19, 2005

(30) Foreign Application Priority Data
Jun. 30, 2005 (GB) GB0513274.1

(51) Int. Cl. H04B 1/44; H04Q 7/00

(52) U.S. Cl. 370/282; 370/329

(57) ABSTRACT

An improved system and method for enabling communication among devices in wireless networks. The present invention involves the introduction of a new terminal class, referred to herein as an accessory class, to a WLAN network. The present invention allows for direct transmissions between accessories and terminals as a part of the service period. According to the present invention, the terminal transmits a request for stream setup to an access point. The access point provides a response to the terminal, after which the terminal prepares an accessory stream setup request to be transmitted to the accessory based upon the received response. The accessory stream setup request indicates the desired operation mode of the accessory.

### FIELD OF THE INVENTION

The present invention relates generally to standards for enabling wireless communication. More particularly, the present invention relates to standards for permitting wireless communication among system access points, terminals and accessories.

### BACKGROUND OF THE INVENTION

The Institute of Electrical and Electronics Engineers, Inc. (“IEEE”) promulgates a variety of standards in various fields, including standards for wired and wireless communication. The IEEE 802.11 specifications are wireless standards that specify an “over-the-air” interface between a wireless client and a base station or access point, as well as among wireless clients. The IEEE 802.11 specifications address both the physical and media access control layers for wireless communication and are tailored to resolve compatibility issues between manufacturers of wireless local area network (WLAN) equipment.

The IEEE 802.11 standard is in the process of being enhanced with a 802.11e Quality of Service (QoS) enhancements standard. The 802.11e standard defines hybrid coordination function based channel access (HCCA) methods. HCCA, together with a scheduled automatic power save delivery (APSD) power save method, generates very low-power data transmission schema. FIG. 1 is a representation of ongoing flow, scheduled APSD requirements for a multicast stream. The service interval between transmission turns must be the same for all terminals within the multicast stream.

Mobile gaming and ad hoc network creation is a relatively new and rapidly growing application field. Many accessories, such as headsets, mass memories, “video glasses” and TV-monitors, create even more requirements for network topology, simplicity and power consumption than have been conventionally addressed.

The new 802.11e standard introduces a direct link setup (DLS) that is used in the event that two stations (STAs), e.g. terminals, that support the QoS facility, but are not access points (APs) (using IEEE 802.11e terminology, they arenon AP QSTAs) wish to exchange data with enhanced distributed channel access (EDCA) directly between each other.

In a normal HCCA data flow, as described in the 802.11e standard, the data is always transmitted between one non AP QSTA and access point (AP). The AP, which supports the QoS facility, is referred to as the QoS access point (QAP according to the IEEE 802.11e standard. Thus, HCCA transmission from a terminal to an accessory needs to have two flows, with one flow from the terminal to the AP and another flow from the AP to an accessory. However, the IEEE 802.11 standard does not define accessory devices. According to IEEE 802.11e, when in infrastructure mode, the non-AP QSTA transmits all frames to the QAP, unless a direct link setup (DLS) data transmission mode is used. The direct data transmission from one terminal to the accessory therefore requires the use of a DLS. However, the DLS does not have a power saving capability, and DLS can use only EDCA.

Furthermore, and in terms of audio communications, many headsets currently use Bluetooth technology to transmit audio data from the terminal to the headset. The Bluetooth radio and 2.4 GHz wireless LAN (WLAN) radios are operating in the same frequency band, which results in transmission errors and degraded performance.

### SUMMARY OF THE INVENTION

The present invention involves the introduction of a new device class, referred to herein as an accessory class, to a WLAN network. The accessory can, in principle, be a non-AP QSTA.

The present invention can be used in ad hoc or infrastructure networks where HCCA-type operations are supported. The present invention enhances the HCCA transmission flow by allowing direct transmissions between accessories and terminals as a part of the service period. According to the present invention, the terminal transmits a request for stream setup to an access point. The access point provides a response to the terminal, after which the terminal prepares an accessory stream setup request to be transmitted to the accessory based upon the received response. The accessory stream setup request indicates the desired operation mode of the accessory.

With the present invention, a terminal can set the stream between itself and an accessory or between an AP and an accessory by only providing the medium access control (MAC) address of the accessory, as well as a security key, in add traffic stream (ADDTS) signaling. Thus, the accessory needs not associate with the AP; the terminal handles all of its accessories and signals the streams for each accessory and AP. The proposed operation flow of the present invention halves the amount of transmitted data, because terminals and accessories can transmit data directly to each other, without the AP in the middle.

By combining all of these aspects together, the HCCA data transmission flow can be introduced to an ad hoc network, and networks can have equipment in two service classes: master terminals (such as telephones) and media handling accessories (e.g., headsets, monitors, etc.).

The present invention enables lower transmission power use between a terminal and an associated accessory. The AP can set the duration field in a QoS CF-Poll frame so that QSTAs set network allocation vectors (NAV) to protect the transmission between the terminal and the accessory during communication. Thus, other terminals do not transmit at the same time as the terminal and the accessory. In many cases, the terminal and the accessory are located close to each other, so that the used transmission power can be substantially lower than the transmission power that is normally required.

The present invention also enhances DLS performance and enables scheduled APSD power saving and HCCA use in scenarios where DLS was previously used. Under the present invention, the AP allocates time for HCCA transmission. With the signaling of the present invention, the AP can also control the transmission times of DLS-like flows.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a general representation of ongoing flow, wherein the scheduled APSD creates power save support for a multicast stream;

FIG. 2 is a representation of a general network topology including an access point, multiple terminals, and multiple accessories according to the present invention;

FIG. 3 is a representation showing the data flow setup process for an accessory beacon transmission;

FIG. 4 is a diagram showing the use of an accessory beacon during communication with an accessory after setup has been completed;

FIG. 5 is a representation of a modified ADDTS request frame according to one embodiment of the present invention;

FIG. 6 is a representation of an ADDTS response frame according to one embodiment of the present invention;

FIG. 7(a) is a representation of an accessory beacon frame according to the present invention;

FIG. 7(b) is a detailed representation of the accessory information field for an accessory beacon frame;

FIG. 7(c) is a depiction of the stay awake element within an accessory beacon frame;

FIG. 7(d) is a representation of the awake parameters field of the accessory beacon frame;

FIG. 7(e) is a depiction of the stream start element field of the accessory beacon frame;

FIG. 8 is a representation of a stream statistics frame according to one embodiment of the present invention;

FIG. 9 is a depiction of a conventional traffic specification (TSPEC) element, along with a detailed representation of the included TS information element;

FIG. 10 is a depiction of an enhanced TSPEC element that can be used to signal different HCCA transmission modes, along with a detailed representation of an enhanced TS information element according to the present invention;

FIG. 11(a) is a representation of an enhanced traffic classification (TCLAS) element to enable traffic classification to accessory and terminal in the same stream according to the present invention;

FIG. 11(b) is a depiction of the frame classifier included in the TCLAS element of FIG. 11(a);

FIG. 12 is a representation of the data flow in a 000 usage scenario according to the present invention in accordance with Table 4 depicted below;

FIG. 13 is a representation of the data flow in a 001 usage scenario according to the present invention in accordance with Table 4 depicted below;

FIG. 14 is a representation of the data flow in a 010 usage scenario according to the present invention in accordance with Table 4 depicted below;

FIG. 15 is a representation of the data flow in a 011 usage scenario according to the present invention in accordance with Table 4 depicted below;

FIG. 16 is a representation of the data flow in a 100 usage scenario according to the present invention in accordance with Table 4 depicted below;

FIG. 17 is a representation of the data flow in a 101 usage scenario according to the present invention in accordance with Table 4 depicted below;

FIG. 18 is a depiction of an example use scenario for game data distribution according to one embodiment of the present invention, where one-way transmission to a WLAN headset is provided, wherein the one-way data frame is first transmitted from the AP to the terminal, the line refers to the delay introduced to the data before it is transmitted to the accessory; and wherein the delay in the terminal can be used to process the received data or change the data format before it is transmitted to the accessory;

FIG. 19 is a perspective view of a mobile telephone that can be used in the implementation of the present invention; and

FIG. 20 is a schematic representation of the telephone circuitry of the mobile telephone of FIG. 19.

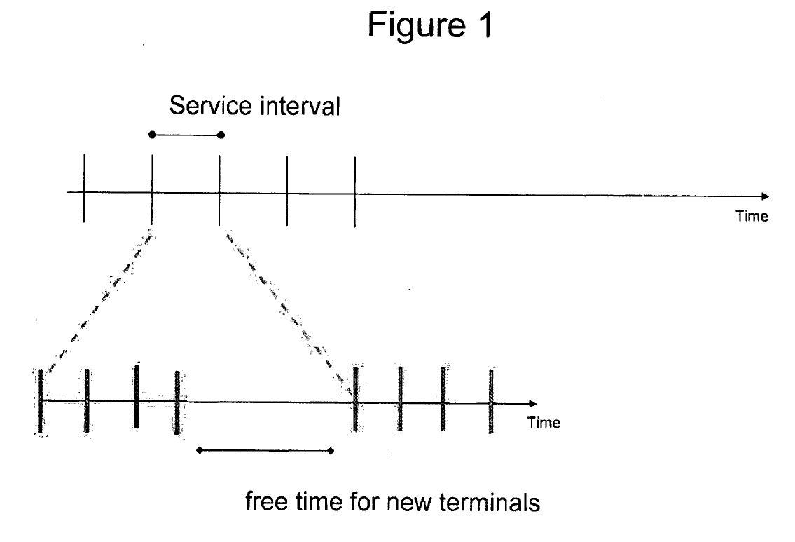

### DETAILED DESCRIPTION OF THE PREFERRED EMBODIMENTS

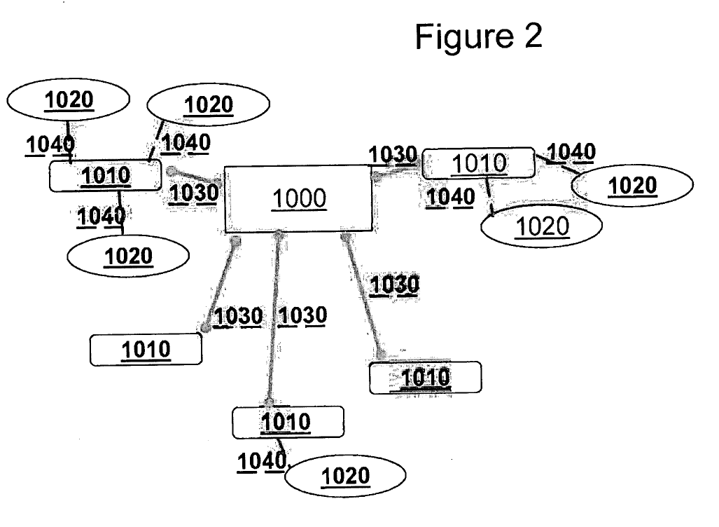

FIG. 2 is a representation of a general network topology according to the present invention, comprising an AP 1000, a plurality of terminals 1010, and a plurality of accessories 1020. Each terminal 100 can have virtually any number of associated accessories 1020, including no accessories at all. The AP 1000 and the terminals 1010 for an infrastructure BSS network as defined in the IEEE 802.11 standard. The AP is referred to herein as an access point which can support QoS facility. An example of such an AP is the QAP presented in IEEE 802.11e. The terminal refers to a device having functionality to operate wirelessly and provide QoS facility such as the non-AP QSTA introduced in IEEE 802.11e. The terminal can connect to a wireless local are network through the APs.

In a simplified traffic stream according to one embodiment of the present invention, three different bodies transmit data: an AP 1000, a terminal 1010, and an accessory 1020. It should be understood that communication between the AP 1000 and the terminal 1010, as well as between the terminal 1010 and the accessory 1020 can be performed using a variety of communication methods, such as a variety of radio communication methods. The stream set-up for the accessory 1020 is taken care of by the terminal 1010. The accessory 1020 does not need to be associated with the AP 1000. The terminal 1010 associates and sets the stream ongoing in ADDTS signaling with the AP 1000. Associations between terminals 1010 and the AP 1000 are represented at 1030. Periodic “accessory beacon” transmissions between terminals 1010 and accessories 1020 are represented at 1040. In other embodiments of the invention, the accessory beacon transmissions may occur without a stream setup, or the terminal 1010 may assume that a stream or data transmission will be provided to the accessory 1020.

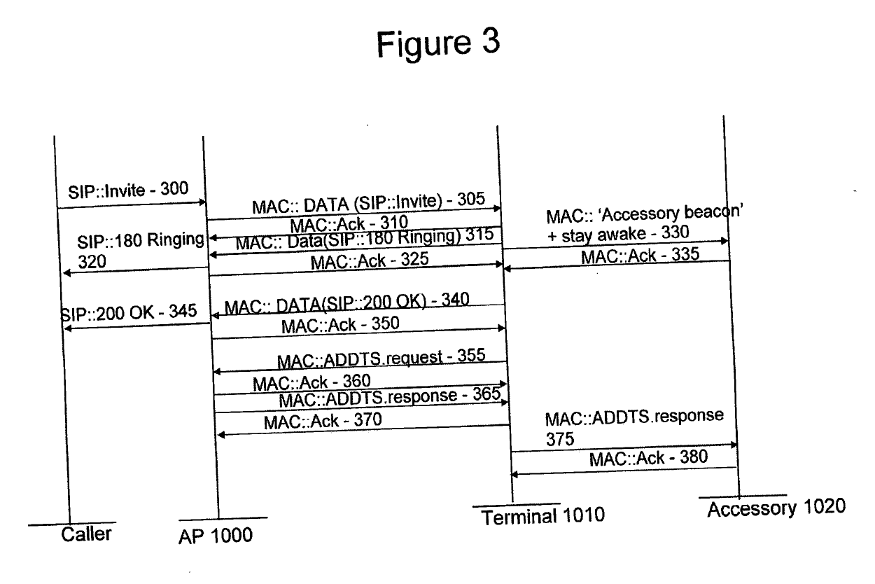

FIG. 3 shows the setup process for an accessory beacon transmission when the stream setup signaling is ongoing or when it is probable that data transmission to the accessory 1020 will occur in the near future. FIG. 3 represents the idea of the terminal-accessory relationship, where the terminal 1010 takes care of the traffic of higher layers than protocol layer 2 or the MAC (medium access control) layer. In FIG. 3, SIP is selected to provide an example of higher layer session setup protocols. Other session setup protocols, such as ITU H.323, can be used.

In the scenario depicted in FIG. 3, the caller first transmits an SIP invitation to the AP 1000 at step 300. The AP 1000 then transmits a corresponding MAC data invitation to the terminal 1010 at step 305, which is acknowledged by the terminal 1010 to the AP 1000 at step 310. At step 315, the terminal 1010 sends a “ringing” message to the AP 1000, and this message is transmitted at step 320 back to the caller and is acknowledged at step 325. At step 330, the terminal 1010 transmits an accessory beacon and “stay awake” instruction to the accessory 1020, which is acknowledged at step 335. In response to this acknowledgment, the terminal 1010 transmits a SIP 200 OK message to the AP 1000, indicating that the terminal 1010 has received an acknowledgment from the accessory 1020. In response to step 340, the AP proceeds to transmit a SIP 200 OK message to the caller at step 345. The AP 1000 then transmits a MAC-level acknowledgment to the terminal 1010 at step 350, indicating that the AP has transmitted the SIP 200 OK message to the caller.

At step 355, the terminal 1010 transmits a MAC-level ADDTS.request message to the AP 1000, which is acknowledged at 360. The ADDTS request informs the recipient (i.e., the access point in FIG. 3) that the terminal 1010 will start sending traffic. The ADDTS terminology and other terminology discussed herein is described in greater detail in the 802.11e standard. The acknowledgment at 360 is followed by a MAC-level ADDTS.response message from the AP 1000 to the terminal 1010 at 365, which is acknowledged at 370. The terminal 1010 then transmits the ADDTS.response message to the accessory 1020 at 375, which is acknowledged by the accessory 1020 at 380.

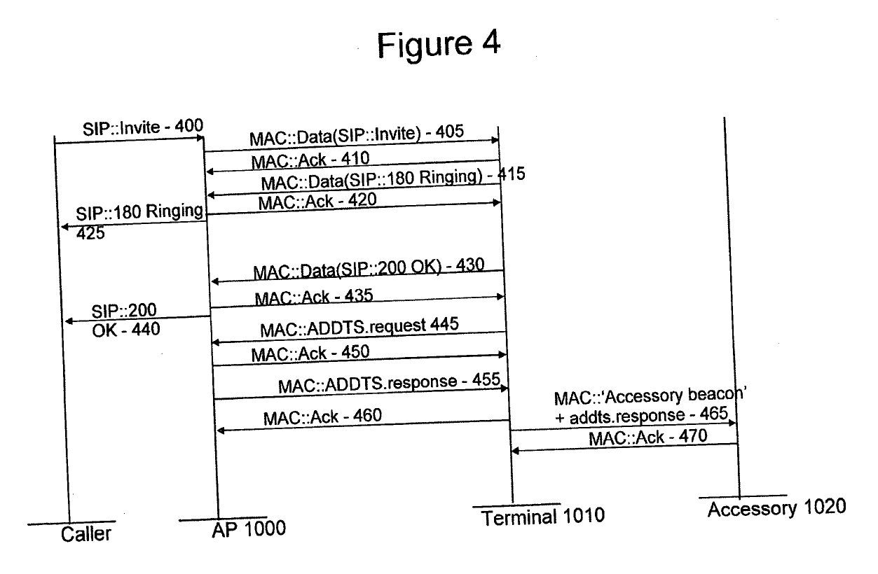

FIG. 4 shows the use of the accessory beacon after the setup has been completed. A SIP-level invitation is transmitted at 400 from the caller to the AP 1000. At 405, a MAC-level invitation is transmitted to the terminal 1010, which is acknowledged at 410. The terminal 1010 then transmits a “ringing” message to the AP 1000 at 415, which is acknowledged at 420. The “ringing” message is then transmitted at the SIP level to the caller at 425.

At 430, the terminal 1010 transmits a MAC-level “OK” message to the AP 1000, which is acknowledged at 435. The AP 1000 then transmits the “OK” message at the SIP level to the caller at 440. At 445, the terminal 1010 transmits an ADDTS.request to the AP 100, which is acknowledged by the AP 1000 at 450. At 455, the AP transmits an ADDTS.response to the terminal 1010 at 455, which is acknowledged at 460. At 465, the terminal 1010 transmits the accessory 1020 “Accessory beacon” and the ADDTS Response, which are acknowledged by the accessory 1020 at 470.

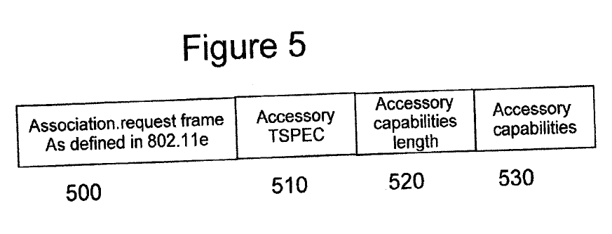

FIG. 5 is a representation of an ADDTS request frame according to one embodiment of the present invention, comprising an Association.request frame 500 as defined in 802.11e, an accessory TSPEC field 510, an accessory capabilities length field 520, and an accessory capabilities field 530. The accessory TSPEC field 510 is used to describe the data transmission options. The value accessory capabilities length field 520 defines the length of the accessory's capabilities field as a number of four octets. The accessory capabilities field 530 can be used to describe higher level parameters for data transmission and data formatting.

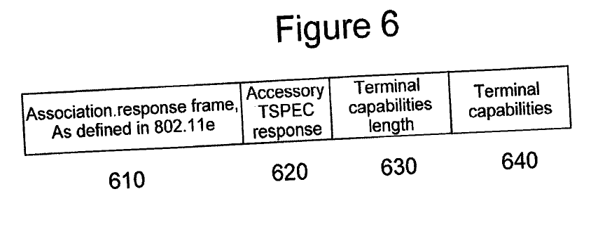

FIG. 6 is a representation of an ADDTS response frame according to the present invention. The ADDTS response frame comprises an Association.response frame 610 as defined in 802.11e, an accessory TSPEC response field 620, a terminal capabilities length field 630 and a terminal capabilities field 640. The accessory TSPEC response field 620 is edited by the terminal 1010. With the TSPEC response field 620, the terminal 1010 describes how it can handle the accessory's TSPEC. The TSPEC negotiation logic follows the ADDTS signaling. The terminal capabilities length field 630 defines the length of the terminal capabilities field as a number of four octets. The terminal capabilities field 640 can be used to describe higher level parameters for data transmission and data formatting.

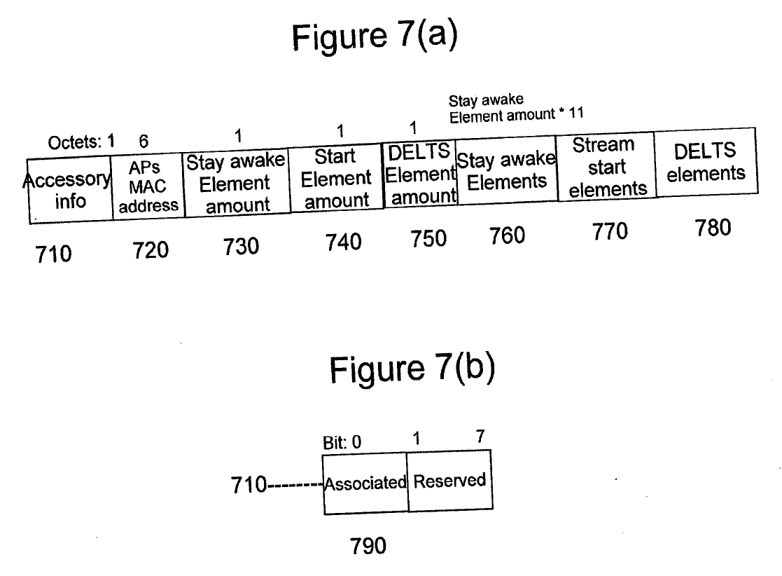

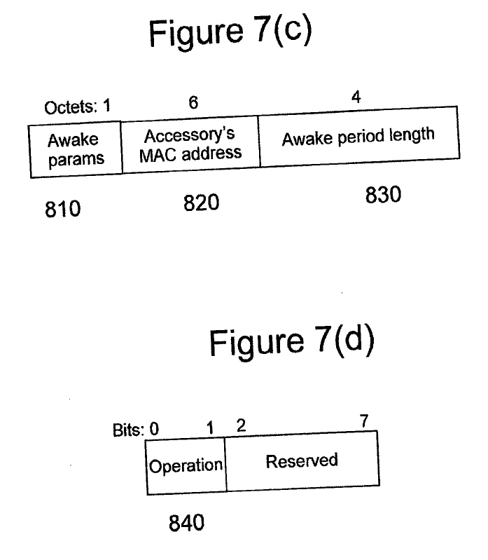

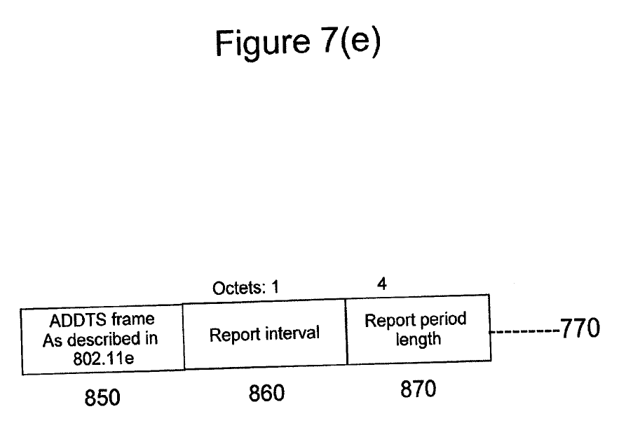

FIG. 7(a) is a representation of an accessory beacon frame according to the present invention, with the number of octets for each field also represented. The accessory beacon frame comprises an accessory info field 710, an APs MAC address field 720, a stay awake element amount field 730, a start element amount field 740, a DELTS element amount field 750, a stay awake element field 760, a stream start elements field 770 and a DELTS elements field 780. DELTS elements simply notify the recipient about the end of the data transmission. However, DELTS elements are not necessarily used to end the data transmission. For example, the AP 1000 can consider the data transmission as ended using timers, which can measure inactivity in the data transmission.

FIG. 7(b) shows the accessory info field 710 in more detail, including an associated bit field 790. The associated bit field 790 is 0 if the terminal 1010 is not associated with the AP 1000. The associated bit field 790 is 1 if the terminal 1010 is associated with the AP 1000, and if the AP's MAC address is valid. The stay awake element amount field 730 is one octet long and contains the number of stay awake elements that are added to the accessory beacon frame. The start element amount field 740 is also one octet long, but instead contains the number of stream start elements that are added to the accessory beacon frame. The DELTS element amount field 750 is one octet long as well, and this field contains the number of DELTS elements that are added to the accessory beacon frame.

FIG. 7(c) is a more detailed depiction of the stay awake element 760, including an awake parameters field 810, an accessory MAC address field 820 and an awake period length field 830. The awake period length field 830 is four octets long and contains an unsigned integer that specifies the awake time, in units of microseconds, that the accessory 1020 stays awake and waits for signaling from the terminal 1010. FIG. 7(d) shows the awake parameters field 810 in more detail, including an operation parameter 840. A bit map for the operation parameter 840 is as follows:

TABLE 1

| Bit 0 | Bit 1 | Operation to Occur in Accessory |
|---|---|---|
| 0 | 0 | Stay in full power mode until the time |
| | | specific in the awake period length has |
| | | elapsed |
| 1 | 1 | Send null or data frame to terminal, go to |
| | | doze when frame is successfully transmitted |
| | | or awake period has elapsed |
| 1 | 0 | Send null or data frame to terminal and stay |
| | | in full power mode until awake period length |
| | | has elapsed |
| 1 | 1 | Reserved |

In the “stay in full power” mode, when the time=0, the accessory can directly enter a power save mode. For the 1-1 arrangement, this arrangement can be used for a “direct sleep” mode in one embodiment of the invention. Additionally, it should be noted that new “stay awake” information overwrites older values.

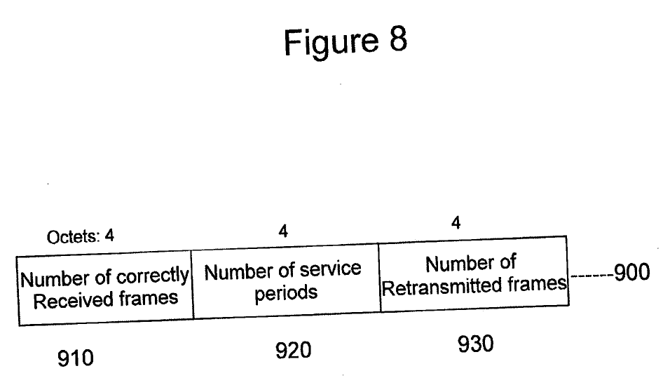

FIG. 7(e) shows the stream start element field 770 in more detail. The stream start element field 770 includes an ADDTS frame 850 as described in the 802.11e standard, a report interval field 860 and a report period length field 870. The report interval field 860 is one octet long and contains an unsigned integer that specifies the beacon interval for the stream status frame transmission. In this instance, a zero value indicates that no stream status frames are transmitted. The report period length field 870 is four octets long and contains an unsigned integer that specifies the time after accessory beacon transmission, in units of microseconds, that the terminal 1010 stays awake and waits for a stream statistic frame, an example of which is shown at 900 in FIG. 8, from the accessory 1020. If the stream statistic frame is not received before the report period expires, it is considered lost and the terminal is permitted to enter a dozing state.

As shown in FIG. 8 and as referred to in the IEEE 802.11k standard, the stream statistics frame 900 includes a “number of correct received frames” field 910, a “number of service periods” field 920, and a “number of retransmitted frames” field 930. The number of correctly received frames is the amount of correctly received frames since the most recent statistics frame transmission. The number of service periods is the number of service periods since the last statistics frame transmission. The number of retransmitted frames is the number of failed attempts to transmit frames since the last statistics frame transmission.

The present invention involves (1) how flow set-up is performed and (2) how the data transmission is accomplished when data transfer is ongoing in the stream. The following discussion assumes the use of one AP 1000, one terminal 1010 and one accessory 1020. However, it should be understood that additional components can also be used in conjunction with the present invention. For setting up a stream, the terminal 1010 takes care of the stream creation for itself and for the accessory 1020. Thus, the accessory 1020 can be created as simply as possible, and the accessory 1020 does not need to be aware of roaming or handover situations.

The present invention introduces signaling between the AP 1000 and terminal 1010. Others in process reports are created to explain how the terminal 1010 and the accessory 1020 signal each other and are aware of each other. It should be noted that the accessory 1020 can also be a terminal, associated to AP. The present invention primarily just specifies the general signaling flow.

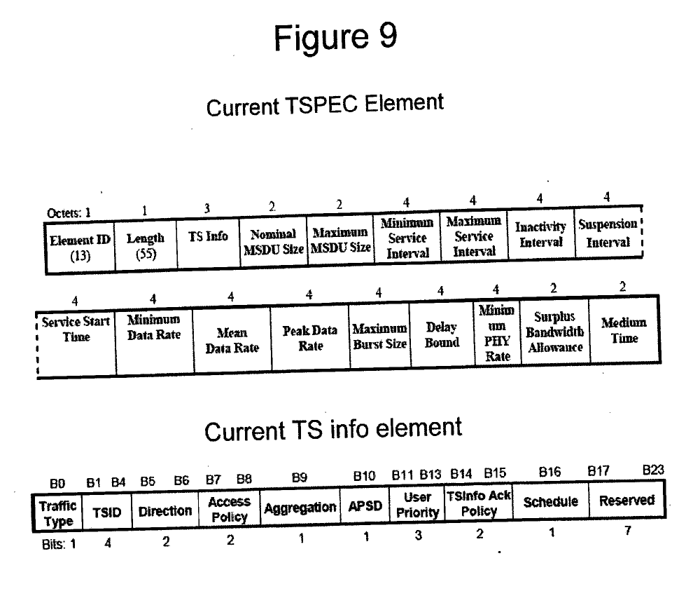

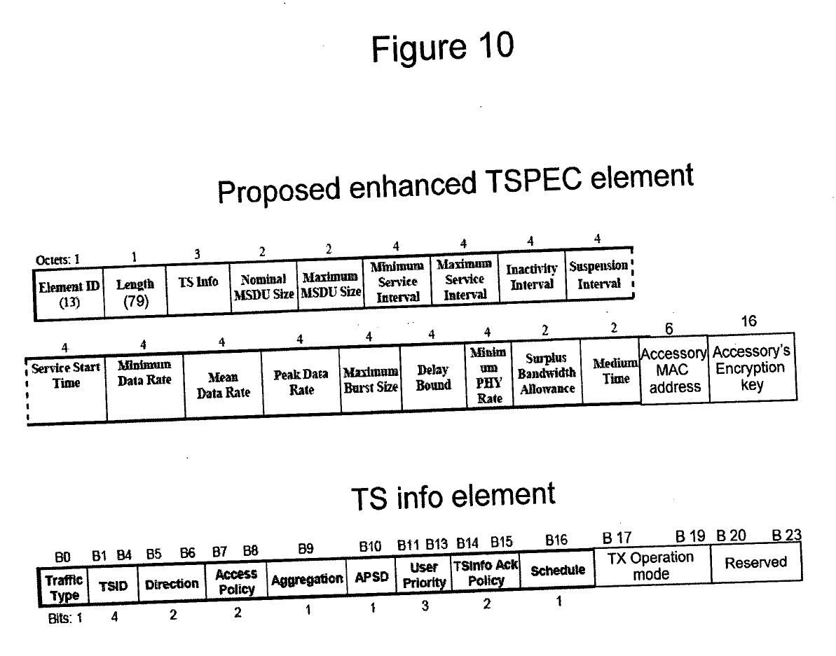

ADDTS frames contain TSPEC information elements, which are used to signal the HCCA stream. The current, conventional TSPEC element, along with a more detailed breakdown of the current TS information element, is shown in FIG. 9. This TSPEC element needs a number of new information fields. In particular, the TSPEC element needs (1) the accessory MAC address; (2) the operation mode indicator, which shows, whether the terminal 1010 or the AP 1000 is transmitting data to the accessory 1020; and (3) the medium time element that is taken into use in scheduled transmissions. This element is needed in order to signal the used transmission time between the terminal 1010 and the accessory 1020. A depiction of an enhanced TSPEC element is shown in FIG. 10, along with an enhanced TS information element.

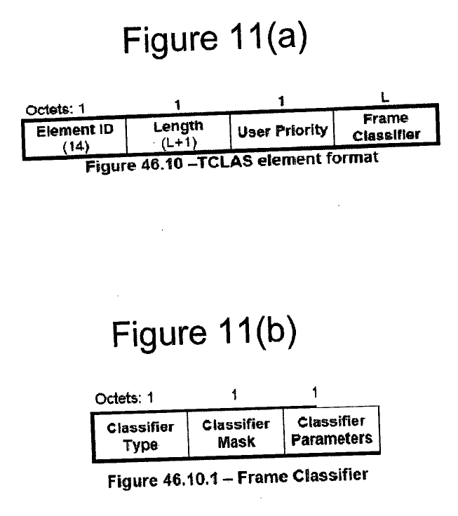

In addition to the above, the TCLAS element requires an extra indication bit. If the AP 1000 communicates directly with the accessory 1020, the TCLAS element needs an indication field to describe which TCLAS elements belong to terminal 1010, and which maps the traffic to the accessory 1020. The ADDTS message may contain several TCLAS elements. Additionally, the TCLAS elements may define the same information that is used both in terminal and accessory communication streams. FIG. 11(a) introduces an enhanced TCLAS element according to the present invention, while FIG. 11(b) shows the frame classifier of the improved TCLAS element in more detail. Regarding the classifier parameters of the frame classifier, the conventional claim classifier types are shown in Table 2 below:

TABLE 2

| Classifier type | Classifier Parameters |
|---|---|
| 0 | Ethernet Parameters |
| 1 | TCP/UDP IP Parameters |
| 2 | IEEE 802.1D/Q Parameters |
| 3-255 | Reserved |

The enhanced frame classifier types according the present invention, on the other hand, are shown in Table 3 below. The “terminal accessory selector” is part of the frame classifier parameter field depicted in FIG. 11(b). The bits in Table 3 indicate the changes for frame classifier type field of FIG. 11(b). It should be noted that Table 3 is only an exemplary way of implementing the terminal-accessory selector to the Frame Classifier and Classifier type field in IEEE 802.11e.

TABLE 3

| Terminal Accessory | Classifier Type (bits | |
|---|---|---|
| Selector (bit 0) | 1-7) | Classifier Parameters |
| 0 = Terminal | 0 | Ethernet Parameters |
| 1 = Accessory | 1 | TCP/UDP IP Parameters |
| | 2 | IEEE 802.1D/Q Parameters |
| | 3-127 | Reserved |

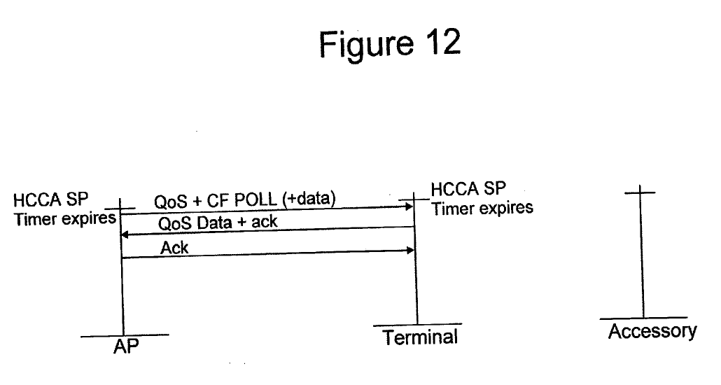

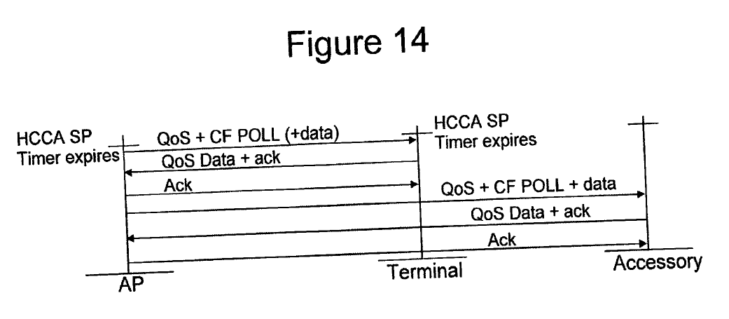

The operation mode field in a TSPEC element, according to the present invention and as depicted in FIG. 10, has a three-bit combination according to Table 4 below. For each three bit combination, a different transmission mode is enabled. These modes are depicted individually in FIGS. 12-17:

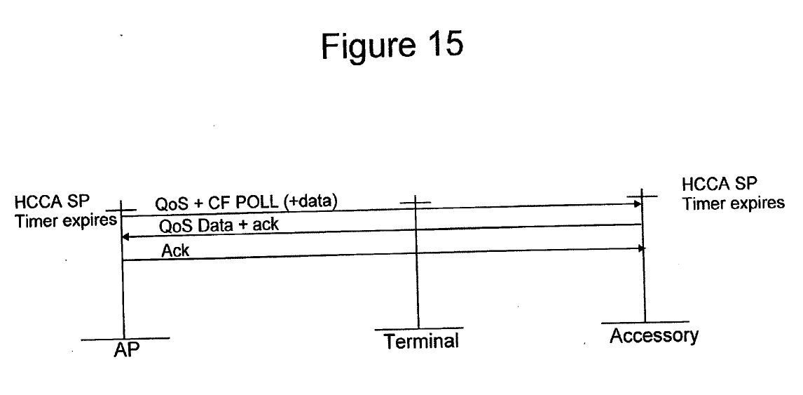

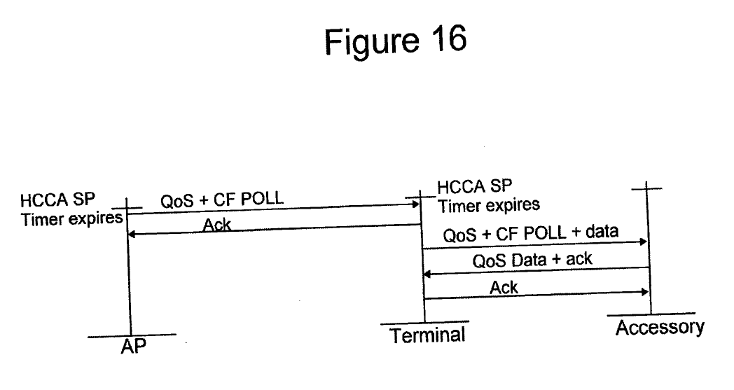

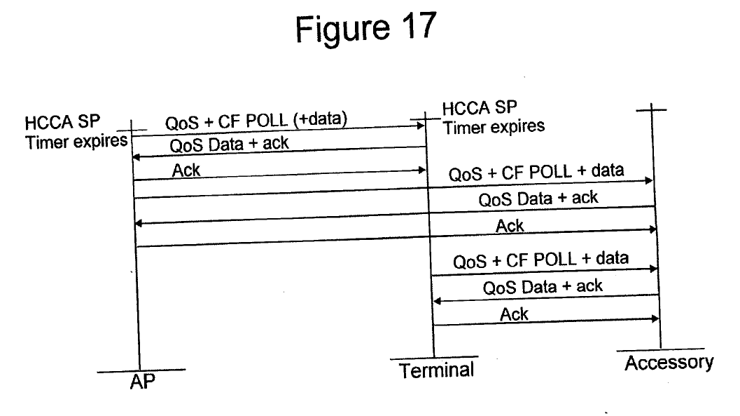

TABLE 4

| Bit | Bit | | |
|---|---|---|---|
| 0 | 1 | Bit 2 | Transmission mode |
| 0 | 0 | 0 | In the service period, only the terminal 1010 and the |
| | | | AP 1000 transmit data, as specified in 802.11e. This |
| | | | data flow is shown in FIG. 12 |
| 0 | 0 | 1 | In the service period, the AP 1000 first transmits data to |
| | | | the terminal 1010. The terminal 1010 then transmits |
| | | | data to the accessory 1020. This data flow is shown in |
| 0 | 1 | 0 | In the service period, the AP 1000 transmits data to |
| | | | terminal 1010, and then the AP 1000 transmits data to |
| | | | the accessory 1020. This data flow is shown in FIG. |
| | | | 14. |
| 0 | 1 | 1 | In the service period, the AP 1000 transmits data only |
| | | | to the accessory 1020. This data flow is shown in |
| | | | FIG. 15. |
| 1 | 0 | 0 | In the service period, only the terminal 1010 and the |
| | | | accessory 1020 transmit data. This data flow is shown |
| | | | in FIG. 16. |
| 1 | 0 | 1 | In the service period, the AP 1000 transmits data to the |
| | | | terminal 100, and then the AP 1000 transmits data to |
| | | | the accessory 1020. After this is complete, the terminal |
| | | | 1010 and the accessory 1020 have allocated |
| | | | transmission time for their own transmissions. This |
| | | | data flow is shown in FIG. 17. |
| 1 | 1 | 0 | Reserved |
| 1 | 1 | 1 | Reserved |

The medium time field, depicted in the TSPEC of FIG. 9, is used to describe the maximum time in one transmission opportunity that can be used for communication between the terminal 1010 and the accessory 1020, depicted in cases 001, 100 and 101 above. Otherwise, the value of the field is unspecified. The medium time value is a sixteen-bit unsigned integer and contains the amount of time admitted to access the medium in units of 32 microsecond periods per synchronized operation period.

In cases 001, 011 and 101, where the AP 1000 communicates directly with the accessory 1020, the terminal 1010 sets the accessory's encryption key field in the TSPEC element to the correct value. This key is used to encrypt data transmissions from the AP 1000 to the accessory 1020. Otherwise, the accessory's encryption key field is left as unspecified.

The TSPEC element describes the characteristics of all traffic in the stream that is transmitted between the AP 1000 and the terminal 1010 or the AP 1000 and the accessory 1020. The “MAC accessory address” in FIG. 10 contains the MAC address of the accessory 1020. Depending upon the security considerations, the terminal 1010 introduces the MAC accessory address for the first time in ADDTS stream. Thus, the accessory 1020 does not need to be associated with the AP 1000. This lowers the power consumption in roaming situations and guarantees that the accessory 1020 and the terminal 1010 are operating in the same AP 1000.

In all transmission options, the data transmission starts from a QoS+CF-POLL or WoS data+CF-POLL frame transmission by the AP 1000. If both the terminal 1010 and the accessory 1020 transmit data, the AP 1000 always polls the terminal 1010. If the terminal 1010 and the accessory 1020 are exchanging data, then the terminal 1010 sends a QoS+CF-Poll or WoS Data+CF-Poll frame to the accessory 1020. This means that the terminal 1010 is polled for data, and the AP 1000 takes control of the medium. This may include an identification of the length of the service period.

Different data transmission scenarios are depicted in FIGS. 12-17. The data transmission flow in FIGS. 12-17 may be initiated by ADDTS requests from the terminal to the AP. As described above, the ADDTS is an exemplary communication method for establishing data transmission flow between a terminal and an AP. The ADDTS request defines the communication rules for the communication between the AP, the terminal and accessory. FIGS. 12 to 17 define that after the AP contacts either the terminal or accessory according to predefined schedule, or if no schedule is determined, when there is data either to the terminal or the accessory. After the poll message, HCCA frame exchange rules are followed. Inside the data stream, all frames are transmitted between short interframe space (SIFS) delays except QoS POLL frames, which have PIFS (point control interframe space) delay after the previous transmission data stream.

FIGS. 12-17 refer to a QoS Data+ack in response to a QoS+CF POLL+data signal. This means that the device at issue transmits data along with the standard acknowledgment. The data is sent with QoS. There can be several data frames communicated between the AP 1000 and the terminal 1010.

If the terminal 1010 and the accessory 1020 exchange data between each other, as in scenarios 001 and 100 introduced in Table 4, then the AP 1000 sets NAV (network allocation vector) protection for the time when terminal and accessory exchange data. The NAV duration can be indicated for the whole stream, the stream including transmissions also other than to and from the AP, in the QoS Poll frame sent by the AP. Thus, the terminal 1010 and the accessory 1020 may use lower transmission power levels in their data transmission.

In the event that transmission time is allocated to transmit data between the terminal 1010 and the accessory 1020, the AP 1000 may not know when the terminal 1010 and the accessory 1020 have transmitted their traffic, because these items may use a lower transmission power level. To address this issue, the terminal 1010 can inform the AP 1000 by sending a CF-END frame that it has transmitted its data. Thus, the unconsumed NAV protected time is available for other transmissions.

In one embodiment of the invention, the terminal 1010 may transmit a CF-END frame if the accessory 1020 does not transmit according to HCCA data flow or respond to retransmissions. Both parties (the terminal 1010 and the accessory 1020) in the stream shall not exceed the maximum HCCA service period duration.

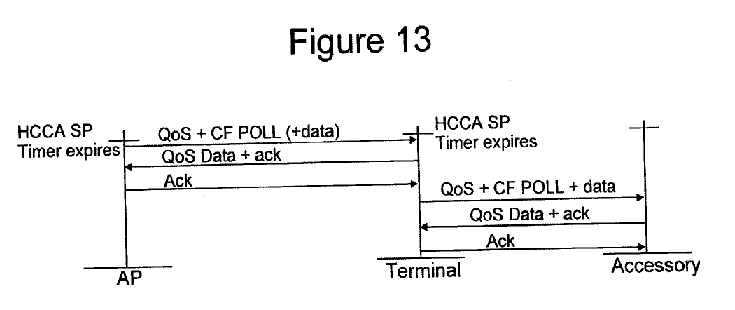

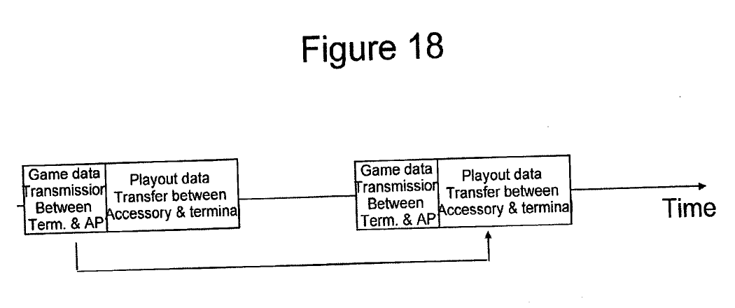

An example use scenario for game data distribution according to the present invention is depicted in FIG. 18. This scenario involves the use of the 001 transmission case depicted in FIG. 13. As is shown in FIG. 18, the terminal 1010 transfers data with the AP 1000 one service period before it transmits at least partially the same data with the accessory 1020. In this scenario, the delay in the terminal 1010 can be used to process the received data or to change the data format before it is transmitted to the accessory 1020. If needed, the terminal 1010 may use more than one service period for the calculations. Thus, the terminal 1010 has one service period to make calculations according to the received data. No extra service periods for accessory-terminal data transfer is needed. This can be particularly beneficial in a gaming or media format handling scenario.

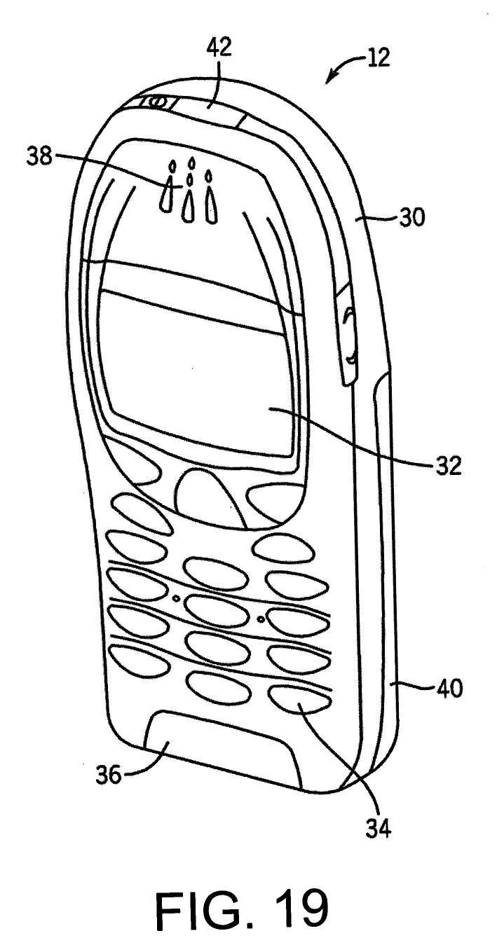

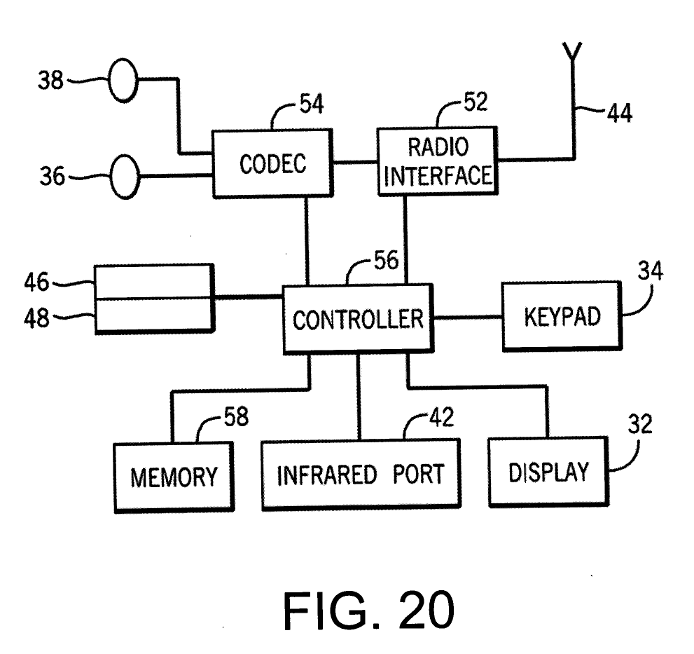

FIGS. 19 and 20 show one representative mobile telephone 12 within which the present invention may be implemented. The mobile telephone 12 can serve as a terminal 1010, an accessory 1020 or an access point 1000 depending upon the particular requirements of the network. The terminal 1010 can comprise a wireless station which supports functions and capabilities to provide parameterized and prioritized QoS. The terminal 1010 can comprise, for example, a non-AP QSTA as defined by IEEE 802.11e. It should be understood, however, that the present invention is not intended to be limited to one particular type of mobile telephone 12 or other electronic device. For example, there are a wide variety of types of cellular phones, portable radio communications devices, personal digital assistants (PDA's), portable computers, and combinations thereof currently on the market. These devices provide a wide range of services, ranging from Internet access to electronic mail to personal organization systems, to even various electronic games. One such portable electronic device incorporating a wide variety of features is marketed by Nokia Corporation under the N-GAGE trademark. This particular product serves as both a video gaming device and a portable telephone.

The mobile telephone 12 of FIGS. 19 and 20 includes a housing 30, a display 32 in the form of a liquid crystal display, a keypad 34, a microphone 36, a speaker 38, a battery 40, an infrared port 42, an antenna 44, a smart card 46 in the form of a universal integrated circuit card (UICC) according to one embodiment of the invention, a card reader 48, radio interface circuitry 52, codec circuitry 54, a controller 56 and a memory 58. Individual circuits and elements are all of a type well known in the art, for example in the Nokia range of mobile telephones. Other types of electronic devices within which the present invention may be incorporated can include, but are not limited to personal digital assistants (PDAs), integrated messaging devices (IMDs), desktop computers, and notebook computers.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc.

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

Software and web implementations of the present invention could be accomplished with standard programming techniques, with rule based logic, and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method for providing communication for an accessory within a local area network, comprising:
transmitting a request for stream setup to an access point;
receiving a response to the request from the access point; and
preparing an accessory stream setup request to be transmitted to an accessory based upon the received response,
wherein the accessory stream setup request indicates the desired operation mode of the accessory.

2. The method of claim 1, wherein the request for stream setup comprises:
an association request frame;
an accessory traffic specification field;
an accessory capabilities length field; and
an accessory capabilities field;

3. The method of claim 1, wherein the response comprises:
an association response frame;
an accessory traffic specification field;
a terminal capabilities length field; and
a terminal capabilities field.

4. The method of claim 1, wherein each request for stream setup and response includes an operation mode field, the operation mode field indicating a mode for future transmissions among the terminal, the accessory and the access point.

5. The method of claim 4, wherein the mode permits the accessory to receive transmissions only from the terminal.

6. The method of claim 4, wherein the mode permits the accessory to receive transmissions only from the access point.

7. The method of claim 4, wherein the mode permits the accessory to receive transmissions from the access point and the terminal.

8. A computer program product for providing communication within a local area network, comprising:
computer code for transmitting a request for stream setup to an access point;
computer code for receiving a response to the request from the access point; and
computer code for preparing an accessory stream setup request to be transmitted to an accessory based upon the received response,
wherein the accessory stream setup request indicates the desired operation mode of the accessory.

9. The computer program product of claim 8, wherein the request for stream setup comprises:
an association request frame;
an accessory traffic specification field;
an accessory capabilities length field; and
an accessory capabilities field;

10. The computer program product of claim 8, wherein the response comprises:
an association response frame;
an accessory traffic specification field;
a terminal capabilities length field; and
a terminal capabilities field.

11. The computer program product of claim 8, wherein each request for stream setup and response includes an operation mode field, the operation mode field indicating a mode for future transmissions among the terminal, the accessory and the access point.

12. An accessory electronic device, comprising:
a processor; and
a memory unit operatively connected to the processor, the memory unit including:
computer code for receiving an accessory stream setup request from a terminal, the terminal having previously received a response from an access point to a request for steam setup from the terminal,
wherein the accessory stream setup request indicates the desired operation of the accessory electronic device.

13. The accessory electronic device of claim 12, wherein each request for stream setup and response field includes an operation mode field, the operation mode field indicating a mode for future transmissions among the terminal, the accessory and the access point.

14. A terminal electronic device, comprising:
a processor; and
a memory unit operatively connected to the processor, the memory unit including:
computer code for transmitting a request for stream setup to an access point;
computer code for receiving a response to the request from the access point; and
computer code for preparing an accessory stream setup request to be transmitted to an accessory based upon the received response,
wherein the accessory stream setup request indicates the desired operation mode of the accessory.

15. The terminal electronic device of claim 14, wherein each request for stream setup and response field includes an operation mode field, the operation mode field indicating a mode for future transmissions among the terminal, the accessory and the access point.

16. A method of providing communication capabilities for a terminal within a network, comprising:
transmitting a request for stream setup to an access point;
receiving a response to the request from the access point; and
preparing an accessory stream setup request to be transmitted to an accessory based upon the received response,
wherein the accessory stream setup request indicates the desired operation mode of the accessory.

17. The method of claim 16, wherein each request for stream setup and response field includes an operation mode field, the operation mode field indicating a mode for future transmissions among the terminal, the accessory and the access point.

18. A communication system within a local area network, comprising:
an access point;
a terminal in communication with the access point; and
an accessory in communication with the terminal,
wherein a request for stream setup is transmitted from the terminal to the access point, the access point providing a response to the terminal, and wherein the terminal prepares an accessory stream setup request to be transmitted to the accessory based upon the received response, the accessory stream setup request indicating the desired operation mode of the accessory.

19. The system of claim 18, wherein each request for stream setup and response field includes an operation mode field, the operation mode field indicating a mode for future transmissions among the terminal, the accessory and the access point.

20. The system of claim 19, wherein the mode permits the accessory to receive transmissions from the access point.
